(19) United States
(12) Patent Application Publication
(10) Pub. No.: US 2026/0063661 A1
(43) Pub. Date: Mar. 5, 2026

(54) Physical Quantity Sensor

(71) Applicant: SEIKO EPSON CORPORATION, Tokyo (JP)

(72) Inventor: Ryoga MORI, Suwa (JP)

(21) Appl. No.: 19/311,108

(22) Filed: Aug. 27, 2025

(30) Foreign Application Priority Data
Aug. 28, 2024 (JP) 2024-146455

(51) Int. Cl. G01P 15/097

(52) U.S. Cl. CPC G01P 15/097

(57) ABSTRACT

A physical quantity sensor includes a base part, a plate-shaped cantilever including a hinge part and a movable part coupled to the base part via the hinge part, and a physical quantity detection element fixed to the base part and the movable part. The cantilever includes a first surface and a second surface in a front-back relationship, a first groove formed on the first surface and extending along a second direction intersecting a first direction in which the hinge part and the movable part are arranged when viewed in a plan view of the cantilever, and a second groove formed on the second surface, extending along the second direction, and overlapping the first groove when viewed in a plan view of the cantilever. The hinge part is defined as a region provided between the first groove and the second groove, and an opening of the first groove and an opening of the second groove are shifted from each other in the first direction.

The present application is based on, and claims priority from JP Application Serial Number 2024-146455, filed Aug. 28, 2024, the disclosure of which is hereby incorporated by reference herein in its entirety.

### BACKGROUND

### 1. Technical Field

The present disclosure relates to a physical quantity sensor.

### 2. Related Art

An inertial sensor described in JP-A-2024-033901 includes: a plate-shaped structure including a base part and a cantilever including a thin constricted part and a movable part coupled to the base part via the constricted part; a vibrator fixed to the base part and the movable part over the constricted part; and a mass part disposed at the movable part.

In such an inertial sensor, when acceleration in a Z-axis direction is applied, the movable part is displaced in relation to the base part with the constricted part serving as a fulcrum. Then, due to this displacement, tensile stress or compressive stress is applied to the vibrator, and the resonance frequency of the vibrator changes according to the magnitude of the applied stress. Therefore, the applied acceleration can be detected, based on the change in the resonance frequency of the vibrator.

JP-A-2024-033901 is an example of the related art.

However, in the inertial sensor having such a configuration, when vibration having a frequency close to the resonance frequency of the cantilever is applied from outside, problems such as output abnormality, destruction, and an increase in vibration rectification error (VRE) may occur (hereinafter also referred to as “trouble due to resonance”). Therefore, in order to make such problems less likely to occur, the resonance frequency of the cantilever needs to be sufficiently high in relation to the frequency band in use so as to prevent resonance.

As method for increasing the resonance frequency of the cantilever, a method of reducing the mass of the movable part may be employed. However, when the mass of the movable part is reduced, there is a problem in that the sensitivity of the inertial sensor decreases. In this way, since the trouble due to the resonance of the cantilever and the sensitivity are in a trade-off relationship, it is difficult to suppress the trouble due to the resonance of the cantilever while maintaining the sensitivity high in the inertial sensor of JP-A-2024-033901.

### SUMMARY

According to an aspect of the present disclosure, a physical quantity sensor includes: a base part; a plate-shaped cantilever including a hinge part and a movable part coupled to the base part via the hinge part, the movable part being displaced in relation to the base part with the hinge part serving as a fulcrum; and a physical quantity detection element fixed to the base part and the movable part over the hinge part, wherein the cantilever includes a first surface and a second surface in a front-back relationship, a first groove formed on the first surface and extending along a second direction intersecting a first direction in which the hinge part and the movable part are arranged when viewed in a plan view of the cantilever, and a second groove formed on the second surface, extending along the second direction, and overlapping the first groove when viewed in a plan view of the cantilever, the hinge part is defined as a region provided between the first groove and the second groove, and an opening of the first groove and an opening of the second groove are shifted from each other in the first direction.

### BRIEF DESCRIPTION OF THE DRAWINGS

FIG. 1 is a top view showing the inside of a physical quantity sensor according to a preferred embodiment.

FIG. 2 is a cross-sectional view taken along a line A-A in FIG. 1.

FIG. 3 is a cross-sectional view showing a cantilever having a related-art structure.

FIG. 4 is a graph showing the relationship between the effective length of a hinge part and the resonance frequency of the cantilever.

FIG. 5 is a graph showing the relationship between the effective length of the hinge part and the sensitivity of the physical quantity sensor.

FIG. 6 shows manufacturing process of a substrate structure.

FIG. 7 is a cross-sectional view for illustrating a method for manufacturing the substrate structure.

FIG. 8 is a cross-sectional view for illustrating the method for manufacturing the substrate structure.

FIG. 9 is a cross-sectional view showing a modification example of the cantilever.

FIG. 10 is a cross-sectional view showing the modification example of the cantilever.

### DESCRIPTION OF EMBODIMENTS

A physical quantity sensor according to the present disclosure will now be described in detail, based on an embodiment shown in the accompanying drawings.

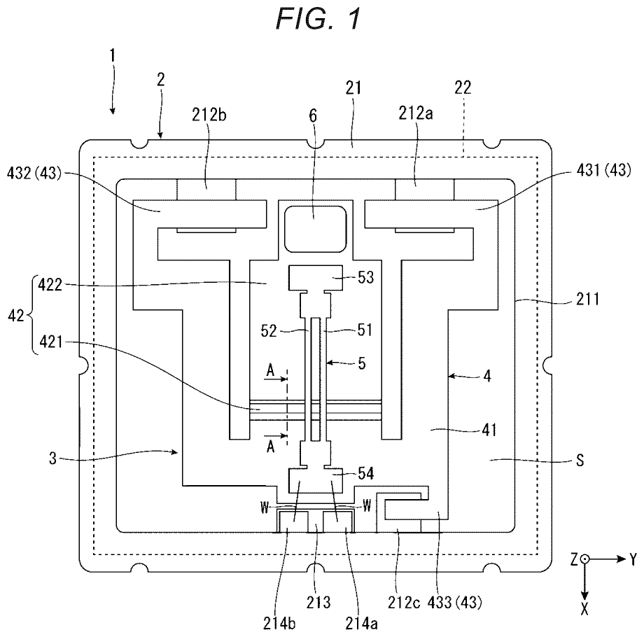

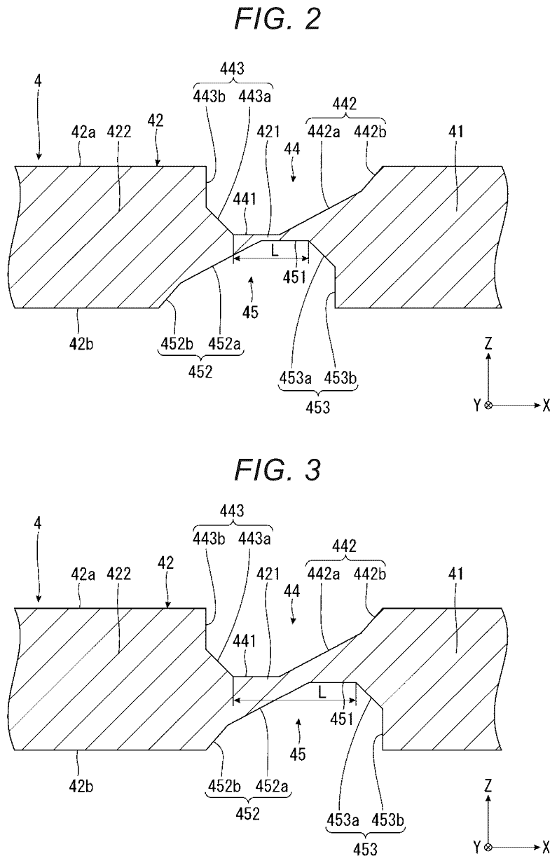

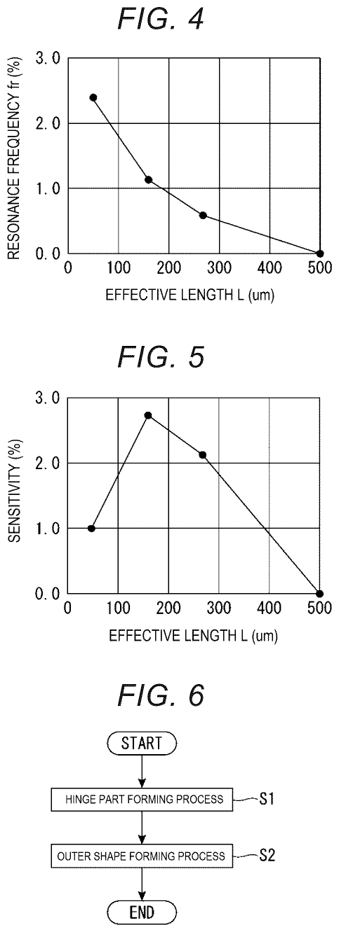

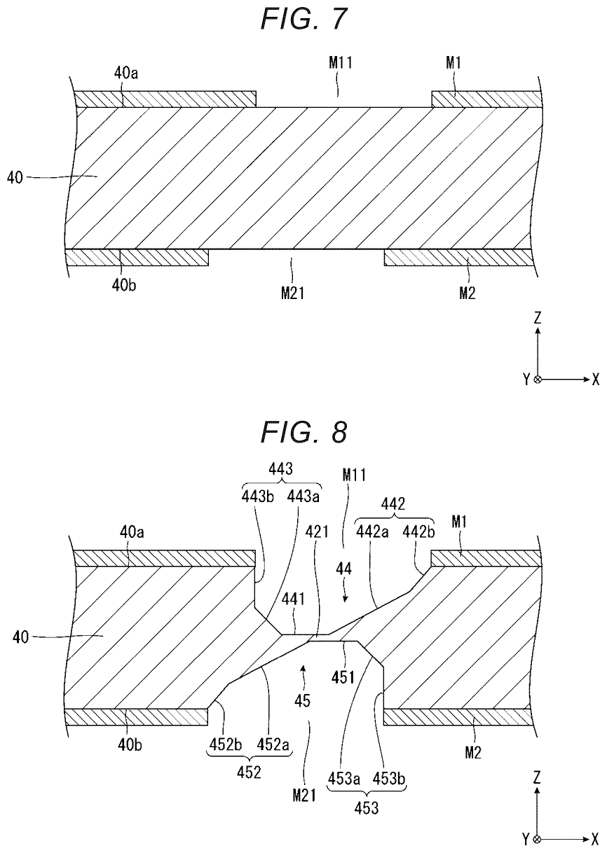

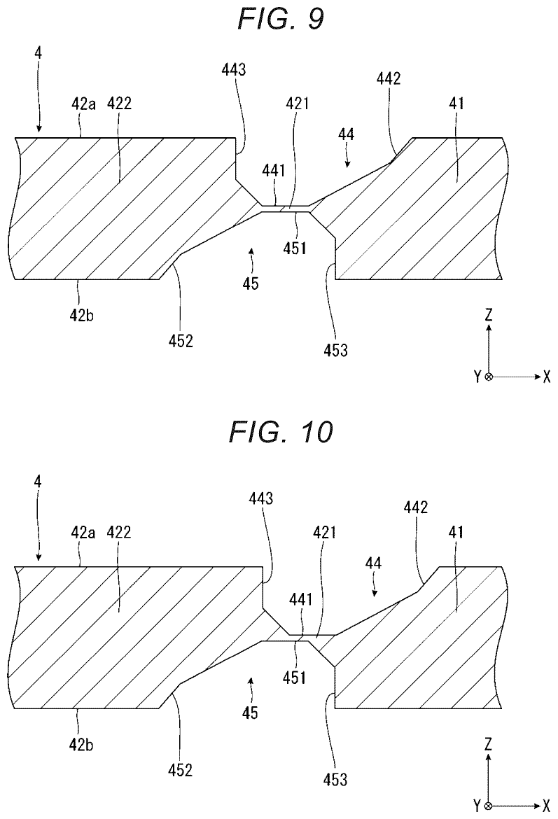

FIG. 1 is a top view showing the inside of a physical quantity sensor according to a preferred embodiment. FIG. 2 is a cross-sectional view taken along a line A-A in FIG. 1. FIG. 3 is a cross-sectional view showing a cantilever having a related-art structure. FIG. 4 is a graph showing the relationship between the effective length of a hinge part and the resonance frequency of the cantilever. FIG. 5 is a graph showing the relationship between the effective length of the hinge part and the sensitivity of the physical quantity sensor. FIG. 6 shows a manufacturing process of a substrate structure. FIGS. 7 and 8 are cross-sectional views for illustrating a method for manufacturing the substrate structure. FIGS. 9 and 10 are cross-sectional views each showing a modification example of the cantilever.

In the description below, for the sake of convenience of description, an X axis, a Y axis, and a Z axis, which are three axes orthogonal to one another, are set in the physical quantity sensor. A direction along the X axis is also referred to as an X-axis direction, a direction along the Y axis is also referred to as a Y-axis direction, and a direction along the Z axis is also referred to as a Z-axis direction. A side indicated by an arrowhead on each axis is also referred to as a “positive side”, and an opposite side is also referred to as a “negative side”. Also, the positive side in the Z-axis direction is also referred to as “up”, and the negative side is also referred to as “down”. A plan view from the Z-axis direction, that is, a plan view of a cantilever 42, described later, is also simply referred to as “a plan view”. In the present application, the meaning of the term “parallel” includes not only a case where objects are parallel to each other but also a case where objects are inclined from each other within a range such that the objects can be regarded as being parallel to each other according to common technical knowledge (for example, about)±5°.

A physical quantity sensor 1 shown in FIG. 1 is an acceleration sensor that detects acceleration in the Z-axis direction. The physical quantity sensor 1 includes a package 2 and a physical quantity sensor element 3 accommodated in the package 2.

First, the package 2 will be described. As shown in FIG. 1, the package 2 includes a base 21 having a recess 211 opening in the upper surface thereof, and a plate-shaped lid 22 joined to the upper surface of the base 21 via a joint member so as to close the opening of the recess 211. Inside the package 2, an airtight internal space S is formed by the recess 211, and the physical quantity sensor element 3 is accommodated in the internal space S.

For example, the base 21 is made of ceramics such as alumina, and the lid 22 is made of a metal material such as Kovar. Thus, the package 2 having excellent mechanical strength is provided. Also, the difference in linear expansion coefficient between these parts can be suppressed to be small, and the generation of thermal stress can be suppressed. However, the material of each of the base 21 and the lid 22 is not particularly limited. The internal space S is in a reduced-pressure state, preferably in a state close to vacuum. Thus, the viscous resistance decreases, and the vibration characteristics of the physical quantity sensor element 3 are improved. The atmosphere in the internal space S is not particularly limited.

Also, as shown in FIG. 1, the base 21 includes three first pedestals 212a, 212b, 212c and one second pedestal 213 protruding from the bottom surface of the recess 211. The physical quantity sensor element 3 is joined to the first pedestals 212a, 212b, 212c via a joint member, not shown. Internal terminals 214a, 214b are disposed at the second pedestal 213. Each of the internal terminals 214a, 214b is electrically coupled to the physical quantity sensor element 3 via a conductive wire W. Although not shown, two external terminals are disposed at the lower surface of the base 21. These two external terminals are electrically coupled to the internal terminals 214a, 214b respectively via an internal wiring, not shown, that is formed in the base 21. Thus, electrical coupling to the physical quantity sensor element 3 via the external terminal can be implemented.

The package 2 has been described above. The physical quantity sensor element 3 will now be described. As shown in FIG. 1, the physical quantity sensor element 3 includes a substrate structure 4 supported by the first pedestals 212a, 212b, 212c, a physical quantity detection element 5 disposed at the substrate structure 4, and a weight part 6 disposed at the substrate structure 4.

The substrate structure 4 is a plate-shaped monolithic structure formed of a quartz crystal substrate, and has a flat plate shape along an X-Y plane orthogonal to the Z axis. The cutting angle of the quartz crystal substrate is not particularly limited as long as the quartz crystal substrate functions as a sensor element using a piezoelectric effect, but in the present embodiment, the quartz crystal substrate is a Z-cut with the optical axis laid in the thickness direction. The X axis, the Y axis, and the Z axis shown in the drawings correspond to the crystal axes of the quartz crystal substrate, with the X axis coinciding with the electrical axis of the quartz crystal substrate, the Y axis coinciding with the mechanical axis, and the Z axis coinciding with the optical axis.

The substrate structure 4 includes a base part 41, the cantilever 42 coupled to the base part 41 and displaced in the Z-axis direction, and an arm part 43 supporting the base part 41.

The arm part 43 includes three arm parts 431, 432, 433. The arm parts 431, 432, 433 are disposed around the base part 41 and are each coupled to the base part 41. The substrate structure 4 is joined to the first pedestals 212a, 212b, 212c of the base 21 via a joint member, not shown, at distal end parts of the arm parts 431, 432, 433. Thus, the substrate structure 4 is supported by the base 21.

The cantilever 42 is plate-shaped and includes a hinge part 421 and a movable part 422 coupled to the base part 41 via the hinge part 421. In the cantilever 42, the hinge part 421 is thinner than the base part 41 and the movable part 422 located on both sides thereof, and the movable part 422 is displaced in the Z-axis direction in relation to the base part 41 with the hinge part 421 serving as a fulcrum.

The physical quantity detection element 5 is a double-ended tuning fork type vibration element formed of a quartz crystal substrate. As the physical quantity detection element 5 is formed of the same material as the substrate structure 4, the linear expansion coefficients of the physical quantity detection element 5 and the substrate structure 4 can be made equal to each other. Therefore, thermal stress is less likely to occur between these parts. Thus, thermal stress caused by the difference in linear expansion coefficient between the physical quantity detection element 5 and the substrate structure 4 is not substantially generated, and a force other than acceleration in the Z-axis direction, which is a detection target, is less likely to be applied to the physical quantity detection element 5. Therefore, the physical quantity sensor 1 having high acceleration measurement accuracy is provided.

As shown in FIG. 1, the physical quantity detection element 5 includes two vibration beams 51, 52, a first base part 53 that terminates at one end of the two vibration beams 51, 52, and a second base part 54 that terminates at the other end of the two vibration beams 51, 52. In the physical quantity detection element 5, the vibration beams 51, 52 are disposed along the X axis, and the physical quantity detection element 5 is joined to the movable part 422 via a joint member, not shown, at the first base part 53, and is joined to the base part 41 via a joint member, not shown, at the second base part 54. That is, the physical quantity detection element 5 is fixed to the base part 41 and the movable part 422 over the hinge part 421.

Also, the physical quantity detection element 5 includes a pair of excitation electrodes, not shown, that are provided in the vibration beams 51, 52. When a drive signal of an AC voltage is applied between these excitation electrodes, the vibration beams 51, 52 perform flexural vibration so as to move away from each other or move toward each other in the Y-axis direction. The pair of excitation electrodes are electrically coupled to the internal terminals 214a, 214b via the wire W.

Now, a method for detecting acceleration in the Z-axis direction using the physical quantity sensor element 3 will be described. When acceleration in the Z-axis direction is applied to the physical quantity sensor 1, the movable part 422 is displaced in the Z-axis direction in relation to the base part 41 with the hinge part 421 serving as the fulcrum. Then, due to this displacement, tensile stress or compressive stress is applied to the physical quantity detection element 5, and the resonance frequency of the physical quantity detection element 5 changes according to the magnitude of the applied stress.

Specifically, when acceleration on the positive side in the Z-axis direction is applied, the movable part 422 is displaced to the negative side in the Z-axis direction in relation to the base part 41, and thus tensile stress is applied to the physical quantity detection element 5 and the resonance frequency of the physical quantity detection element 5 increases. On the other hand, when acceleration on the negative side in the Z-axis direction is applied, the movable part 422 is displaced to the positive side in the Z-axis direction in relation to the base part 41, and thus compressive stress is applied to the physical quantity detection element 5 and the resonance frequency of the physical quantity detection element 5 decreases. Therefore, the physical quantity sensor 1 can detect acceleration, based on the change in the resonance frequency of the physical quantity detection element 5. The resonance frequency of the physical quantity detection element 5 can be detected by detecting the potential of a detection electrode, not shown, that is provided at the surface of the vibration beams 51, 52.

Back to the description of the configuration of the physical quantity sensor element 3, as shown in FIG. 1, the weight part 6 is joined to a distal end part of the upper surface of the movable part 422 via a joint member, not shown. As the weight part 6 is disposed at the movable part 422, the mass of the movable part 422 increases. Therefore, the movable part 422 is easily displaced even with a small acceleration, and the sensitivity (resolution) of the physical quantity sensor 1 is improved. The weight part 6 is made of a metal material having a relatively large specific gravity, such as copper (Cu), gold (Au), tungsten (W), or various alloys. Thus, the weight 6 can be made sufficiently heavy while the size of the weight 6 is suppressed.

The overall configuration of the physical quantity sensor 1 has been briefly described. The cantilever 42, which is also a feature of the physical quantity sensor 1, will now be described in detail.

FIG. 2 is a cross-sectional view taken along the line A-A in FIG. 1. As shown in FIG. 2, the cantilever 42 has an upper surface 42a as a first surface and a lower surface 42b as a second surface, which are in a front-back relationship. The upper surface 42a and the lower surface 42b are parallel to each other and extend along the X-Y plane. The cantilever 42 has a first groove 44 formed on the upper surface 42a and a second groove 45 formed on the lower surface 42b. Each of the first groove 44 and the second groove 45 extends straight along the Y-axis direction, which is a second direction intersecting the X-axis direction, which is a first direction in which the hinge part 421 and the movable part 422 are arranged when viewed in a plan view. The first groove 44 and the second groove 45 overlap each other when viewed in a plan view, and a thin part sandwiched between the first groove 44 and the second groove 45 is defined as the hinge part 421.

The first groove 44 and the second groove 45 are wet-etched grooves formed by wet etching. By wet etching, the first groove 44 and the second groove 45 can be easily formed. As described above, since the first groove 44 and the second groove 45 have a wet-etched surface, crystal planes of quartz crystal appear on each of the inner surfaces of the first groove 44 and the second groove 45.

Specifically, as shown in FIG. 2, the first groove 44 includes a first bottom surface 441 parallel to the upper surface 42a, a first sloped surface 442 located on the positive side of the first bottom surface 441 in the X-axis direction, and a second sloped surface 443 located on the negative side of the first bottom surface 441 in the X-axis direction and having a steeper slope than the first sloped surface 442. The first sloped surface 442 includes a gentle slope surface 442a located on the lower side (first bottom surface 441 side) and a steep slope surface 442b located on the upper side (upper surface 42a side) and having a steeper slope than the gentle slope surface 442a. Similarly, the second sloped surface 443 has a gentle slope surface 443a located on the lower side (first bottom surface 441 side) and a steep slope surface 443b located on the upper side (upper surface 42a side) and having a steeper slope than the gentle slope surface 443a. The gentle slope surface 442a has a gentler slope than the gentle slope surface 443a, and the steep slope surface 442b has a gentler slope than the steep slope surface 443b. Note that “the second sloped surface 443 has a steeper slope than the first sloped surface 442” means that the length of the second sloped surface 443 in the X-axis direction is shorter than the length of the first sloped surface 442 in the X-axis direction.

The second groove 45 appears in Y-axis rotational symmetry with the first groove 44. That is, the second groove 45 includes a second bottom surface 451 parallel to the lower surface 42b, a third sloped surface 452 located on the negative side of the second bottom surface 451 in the X-axis direction, and a fourth sloped surface 453 located on the positive side of the second bottom surface 451 in the X-axis direction and having a steeper slope than the third sloped surface 452. The third sloped surface 452 includes a gentle slope surface 452a located on the upper side (second bottom surface 451 side) and a steep slope surface 452b located on the lower side (lower surface 42b side) and having a steeper slope than the gentle slope surface 452a. Similarly, the fourth sloped surface 453 includes a gentle slope surface 453a located on the upper side (second bottom surface 451 side) and a steep slope surface 453b located on the lower side (lower surface 42b side) and having a steeper slope than the gentle slope surface 453a. The gentle slope surface 452a has a gentler slope than the gentle slope surface 453a, and the steep slope surface 452b has a gentler slope than the steep slope surface 453b. Note that “the fourth sloped surface 453 has a steeper slope than the third sloped surface 452” means that the length of the fourth sloped surface 453 in the X-axis direction is shorter than the length of the third sloped surface 452 in the X-axis direction.

However, the number of crystal planes appearing on the inner surface of the first groove 44 is not particularly limited. Similarly, the number of crystal planes appearing on the inner surface of the second groove 45 is not particularly limited.

The first groove 44 and the second groove 45 having the above-described shapes are disposed such that the first bottom surface 441 and the second bottom surface 451 overlap each other when viewed in a plan view. Openings of the first groove 44 and the second groove 45 are shifted from each other in the X-axis direction. Specifically, the opening of the first groove 44 is shifted to the positive side in the X-axis direction in relation to the opening of the second groove 45 so that the second sloped surface 443 and the fourth sloped surface 453, which have a steep slope, are close to each other. As the first groove 44 and the second groove 45 are thus shifted in the X-axis direction, the following effects can be achieved. In the description below, a separation distance between an end part of the first bottom surface 441 on the negative side in the X-axis direction and an end part of the second bottom surface 451 on the positive side in the X-axis direction is defined as an effective length L of the hinge part 421.

First, a problem in a case where the opening of the first groove 44 and the opening of the second groove 45 are not shifted in the X-axis direction, as shown in FIG. 3, will be described. Hereinafter, this structure is also referred to as a “related-art structure”. Since the first groove 44 and the second groove 45 are wet-etched grooves and crystal planes of quartz crystal appear on the inner surfaces thereof, the first bottom surface 441 and the second bottom surface 451 in the related-art structure are largely away from each other in the X-axis direction and the effective length L is long accordingly. As the effective length L increases, the rigidity of the hinge part 421 serving as the fulcrum decreases and it becomes difficult to increase a resonance frequency fr of the cantilever 42. Moreover, as the effective length L increases, the occupancy rate of the hinge part 421 in the cantilever 42 increases and the mass of the movable part 422 decreases accordingly, and therefore it becomes difficult to increase the sensitivity of the physical quantity sensor. In this way, in the related-art structure, it is difficult to increase the resonance frequency fr of the cantilever 42 and to increase the sensitivity of the physical quantity sensor. For example, the sensitivity can be increased by increasing the mass of the weight part 6, but there is a new problem in that the size of the physical quantity sensor increases accordingly.

In contrast to such a related-art structure, in the physical quantity sensor 1 according to the present embodiment, since the opening of the first groove 44 and the opening of the second groove 45 are shifted from each other in the X-axis direction, as shown in FIG. 2, the first bottom surface 441 and the second bottom surface 451 overlap each other and the effective length L of the hinge part 421 is shorter than in the related-art structure accordingly. As the effective length L decreases, the rigidity of the hinge part 421 serving as the fulcrum increases and therefore the resonance frequency fr of the cantilever 42 can be easily increased. Moreover, as the effective length L becomes shorter, the occupancy rate of the hinge part 421 in the cantilever 42 decreases and the mass of the movable part 422 increases accordingly, and therefore the sensitivity of the physical quantity sensor 1 can be easily increased. In this way, in the physical quantity sensor 1 according to the present embodiment, the resonance frequency fr of the cantilever 42 can be easily increased and the sensitivity of the physical quantity sensor 1 can be easily increased as well. That is, in the physical quantity sensor 1 according to the present embodiment, since the resonance frequency fr of the cantilever 42 can be increased without decreasing the volume of the movable part 422, both an increase in the resonance frequency fr of the cantilever 42 and an increase in the sensitivity of the physical quantity sensor 1 can be achieved. Thus, the physical quantity sensor 1 in which the trouble due to the resonance of the cantilever can be effectively suppressed while high sensitivity is maintained is provided.

FIG. 4 shows the relationship between the effective length L and the resonance frequency fr of the cantilever 42. L=500 μm in FIG. 4 corresponds to the related-art structure. As is apparent from FIG. 4, by making the effective length L shorter than in the related-art structure, the resonance frequency fr of the cantilever 42 can be increased as compared with the related-art structure. FIG. 5 shows the relationship between the effective length L and the sensitivity of the physical quantity sensor 1. As in FIG. 4, L=500 μm in FIG. 5 corresponds to the related-art structure. As is clear from FIG. 5, by making the effective length L shorter than in the related-art structure, the sensitivity of the physical quantity sensor 1 can be increased as compared with the related-art structure.

In particular, by setting the effective length L to 100 μm or more and 200 μm or less, both the resonance frequency fr of the cantilever 42 and the sensitivity of the physical quantity sensor 1 can be increased at a sufficient level. Therefore, the effective length L is preferably L<500 μm, and more preferably 100 μm≤L≤200 μm. However, the effective length L is not particularly limited.

The physical quantity sensor 1 has been described above. As described above, such a physical quantity sensor 1 includes: the base part 41; the plate-shaped cantilever 42 including the hinge part 421 and the movable part 422 coupled to the base part 41 via the hinge part 421, the movable part 422 being displaced in relation to the base part 41 with the hinge part 421 serving as the fulcrum; and the physical quantity detection element 5 fixed to the base part 41 and the movable part 422 over the hinge part 421. Also, the cantilever 42 includes: the upper surface 42a, which the first surface, and the lower surface 42b, which is the second surface, the upper surface 42a and the lower surface 42b being in a front-back relationship; the first groove 44 formed on the upper surface 42a and extending along the Y-axis direction, which is the second direction intersecting the X-axis direction, which is the first direction in which the hinge part 421 and the movable part 422 are arranged when viewed in a plan view of the cantilever 42; and the second groove 45 formed on the lower surface 42b, extending along the Y-axis direction, and overlapping the first groove 44 when viewed in a plan view of the cantilever 42. The hinge part 421 is defined as a region provided between the first groove 44 and the second groove 45, and the opening of the first groove 44 and the opening of the second groove 45 are shifted from each other in the X-axis direction. With such a configuration, the effective length L of the hinge part 421 can be suppressed to be short. Therefore, the resonance frequency fr of the cantilever 42 can be increased without reducing the volume of the movable part 422. Thus, the physical quantity sensor 1 in which the trouble due to the resonance of the cantilever can be effectively suppressed while high sensitivity is maintained is provided.

As described above, the first bottom surface 441 of the first groove 44 and the second bottom surface 451 of the second groove 45 overlap each other when viewed in a plan view of the cantilever 42. With such a configuration, the effective length L of the hinge part 421 can be suppressed to be short.

Also, as described above, the base part 41 and the cantilever 42 are a monolithic structure formed of a quartz crystal substrate, and each of the first groove 44 and the second groove 45 is a wet-etched groove. With such a configuration, crystal planes of quartz crystal appear in the first groove 44 and the second groove 45. Therefore, when the opening of the first groove 44 and the opening of the second groove 45 are not shifted from each other in the X-axis direction, that is, in the case of the above-described related-art structure, the effective length L of the hinge part 421 tends to be long. Therefore, the effect of the physical quantity sensor 1 (the effect generated by shifting the opening of the first groove 44 and the opening of the second groove 45 from each other in the X-axis direction) can be achieved more prominently.

Also, as described above, the first groove 44 includes the first bottom surface 441, the first sloped surface 442 located on the positive side in the X-axis direction (one side in the first direction) of the first bottom surface 441, and the second sloped surface 443 located on the negative side in the X-axis direction (the other side in the first direction) of the first bottom surface 441 and having a steeper slope than the first sloped surface 442. The second groove 45 includes the second bottom surface 451, the third sloped surface 452 located on the negative side of the second bottom surface 451 in the X-axis direction, and the fourth sloped surface 453 located on the positive side of the second bottom surface 451 in the X-axis direction and having a steeper slope than the third sloped surface 452. The opening of the first groove 44 is shifted to the positive side in the X-axis direction in relation to the opening of the second groove 45. With such a configuration, the effective length L of the hinge part 421 can be suppressed to be short.

A method for manufacturing the substrate structure 4 will now be described. As shown in FIG. 6, the method for manufacturing the substrate structure 4 includes a hinge part forming process S1 of forming the hinge part 421 and an outer shape forming process S2 of forming the outer shape of the substrate structure 4.

### Hinge Part Forming Process S1

First, a Z-cut quartz crystal substrate 40 as a base material of the substrate structure 4 is prepared. Next, as shown in FIG. 7, a mask M1 provided with an opening M11 corresponding to the first groove 44 is formed on an upper surface 40a of the prepared quartz crystal substrate 40, and a mask M2 provided with an opening M21 corresponding to the second groove 45 is formed on a lower surface 40b of the quartz crystal substrate 40. The opening M11 is shifted to the positive side in the X-axis direction in relation to the opening M21. Next, the quartz crystal substrate 40 is wet-etched via the masks M1 and M2, and the first groove 44 and the second groove 45 are thus formed, as shown in FIG. 8.

### Outer Shape Forming Process S2

Next, the quartz crystal substrate 40 is patterned using various etching techniques such as wet etching and dry etching, and the outer shape of the substrate structure 4 is thus formed. The substrate structure 4 is thus provided. With such a manufacturing method, the substrate structure 4 can be easily formed.

While the physical quantity sensor according to the present disclosure has been described based on the illustrated embodiment, the present disclosure is not limited thereto and the configuration of each part can be replaced with any configuration having similar functions. Also, any other configuration may be added to the present disclosure.

For example, in the above-described embodiment, the first bottom surface 441 is shifted to the negative side in the X-axis direction in relation to the second bottom surface 451, but the present disclosure is not limited thereto, and the first bottom surface 441 and the second bottom surface 451 may coincide with each other as shown in FIG. 9, or the first bottom surface 441 may be shifted to the positive side in the X-axis direction in relation to the second bottom surface 451 as shown in FIG. 10.

What is claimed is:

1. A physical quantity sensor comprising:
a base part;
a plate-shaped cantilever including a hinge part and a movable part coupled to the base part via the hinge part, the movable part being displaced in relation to the base part with the hinge part serving as a fulcrum; and
a physical quantity detection element fixed to the base part and the movable part over the hinge part, wherein
the cantilever includes
a first surface and a second surface in a front-back relationship,
a first groove formed on the first surface and extending along a second direction intersecting a first direction in which the hinge part and the movable part are arranged when viewed in a plan view of the cantilever, and
a second groove formed on the second surface, extending along the second direction, and overlapping the first groove when viewed in the plan view of the cantilever,
the hinge part is defined as a region provided between the first groove and the second groove, and
an opening of the first groove and an opening of the second groove are shifted from each other in the first direction.

2. The physical quantity sensor according to claim 1, wherein
a first bottom surface of the first groove and a second bottom surface of the second groove overlap each other when viewed in the plan view of the cantilever.

3. The physical quantity sensor according to claim 2, wherein
the base part and the cantilever are a monolithic structure formed of a quartz crystal substrate, and
each of the first groove and the second groove is a wet-etched groove.

4. The physical quantity sensor according to claim 3, wherein
the first groove includes the first bottom surface, a first sloped surface located on one side in the first direction of the first bottom surface, and a second sloped surface located on the other side in the first direction of the first bottom surface and having a steeper slope than the first sloped surface,
the second groove includes the second bottom surface, a third sloped surface located on the other side in the first direction of the second bottom surface, and a fourth sloped surface located on the one side in the first direction of the second bottom surface and having a steeper slope than the third sloped surface, and
the opening of the first groove is shifted to the one side in the first direction in relation to the opening of the second groove.
